(19) United States
(12) Patent Application Publication
(10) Pub. No.: US 2006/0038945 A1
(43) Pub. Date: Feb. 23, 2006

(54) Liquid crystal display device

(75) Inventor: Chiu-Lien Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/206,926

(22) Filed: Aug. 18, 2005

(30) Foreign Application Priority Data
Aug. 23, 2004 (TW) 93125429

(51) Int. Cl. G02F 1/1335

(52) U.S. Cl. 349/114

(57) ABSTRACT

An LCD device (10) includes a first substrate (21) and a second substrate (22), a liquid crystal layer (111) interposed between the substrates. A common electrode (221) disposes at an inner surface of the first substrate, a pixel electrode (210) disposes at an inner surface of the second substrate, the pixel electrode have an uneven surface defining a plurality of bumps (61). Each pixel regions of the LCD device includes a reflection region and a transmission region. A pre-tilt angle of liquid crystal molecules adjacent to one of the substrates is in the range from 0° to 15°, and a pre-tilt angle of liquid crystal molecules adjacent to another substrate is in the range from 75° to 90°. This structure ensures the LCD device has a fast response time.

### FIELD OF THE INVENTION

The present invention relates to liquid crystal display (LCD) devices, and more particularly to a reflection/transmission type LCD device capable of providing a display both in a reflection mode and a transmission mode.

### BACKGROUND

Conventionally, there have been three types of LCD devices commercially available: a reflection type LCD device utilizing ambient light, a transmission type LCD device utilizing backlight, and a semi-transmission type LCD device equipped with a half mirror and a backlight.

With a reflection type LCD device, a display becomes less visible in a dim environment. In contrast, with a transmission type LCD device, a display becomes hazy in strong ambient light (e.g., outdoor sunlight). Thus researchers sought to provide an LCD device capable of functioning in both modes so as to yield a satisfactory display in any environment. In due course, a semi-transmission type LCD device was disclosed in Japanese Laid-Open Publication No. 7-333598.

However, the above-mentioned conventional semi-transmission type LCD device has the following problems.

The conventional semi-transmission type LCD device uses a half mirror in place of a reflective plate used in a reflection type LCD device, and has a minute transmission region (e.g., minute holes in a metal thin film) in a reflection region, thereby providing a display by utilizing transmitted light as well as reflected light. Since reflected light and transmitted light used for a display pass through the same liquid crystal layer, an optical path of reflected light becomes twice as long as that of transmitted light. This causes a large difference in light retardation of the liquid crystal layer with respect to reflected light and transmitted light. Thus, a satisfactory display cannot be obtained. Furthermore, a display in a reflection mode and a display in a transmission mode are superimposed on each other, so that the respective displays cannot be separately optimized. This results in difficulty in providing a color display, and tends to cause a blurred display.

### SUMMARY

In a preferred embodiment, a liquid crystal display device includes a first substrate and a second substrate, and a liquid crystal layer having liquid crystal molecules interposed between the first and second substrates. A common electrode and an upper alignment film are orderly disposed at an inner surface of the first substrate. A pixel electrode and a lower alignment film are orderly disposed at an inner surface of the second substrate.

The liquid crystal display device includes a plurality of pixel regions. Each of the pixel regions defines a reflection region and a transmission region. The pixel electrode in each reflection region cooperates is configured as a reflection electrode, and the pixel electrode in each transmission region is configured as a transmission electrode. A thickness of the liquid crystal layer in the reflection regions is less than a thickness of the liquid crystal layer in the transmission regions. A pre-tilt angle of liquid crystal molecules adjacent to one of the substrates is in the range from 0° to 15°, and a pre-tilt angle of liquid crystal molecules adjacent to the other substrate is in the range from 75° to 90°.

In various embodiments, the reflection electrodes each have an uneven surface defining a plurality of bumps. Preferably, both the reflection electrodes and the transmission electrodes each have an uneven surface defining a plurality of bumps. Alternatively, a passivation layer may be disposed at one of the substrates corresponding to the reflection regions, wherein the passivation layer has an uneven surface defining a plurality of bumps.

In summary, in each pixel region of the LCD device, the liquid crystal molecules adjacent to the two substrates have pre-tilt angles in the range from 0° to 15° and 75° to 90° respectively, which ensures that the liquid crystal molecules can more easily twist when a voltage is applied thereto. Thereby, the LCD device has a fast response time.

Other advantages and novel features will become more apparent from the following detailed description when taken in conjunction with the accompanying drawings.

### BRIEF DESCRIPTION OF THE DRAWINGS

FIG. 1 is a schematic, exploded, side cross-sectional view of part of an LCD device according to a first embodiment of the present invention.

FIG. 2 is a schematic, exploded, side cross-sectional view of part of an LCD device according to a second embodiment of the present invention.

FIG. 3 is a schematic, exploded, side cross-sectional view of part of an LCD device according to a third embodiment of the present invention.

FIG. 4 is a schematic, exploded, side cross-sectional view of part of an LCD device according to a fourth embodiment of the present invention.

FIG. 5 is a schematic, exploded, side cross-sectional view of part of an LCD device according to a fifth embodiment of the present invention.

FIG. 6 is a schematic, exploded, side cross-sectional view of part of an LCD device according to a sixth embodiment of the present invention.

### DETAILED DESCRIPTION OF PREFERRED EMBODIMENTS

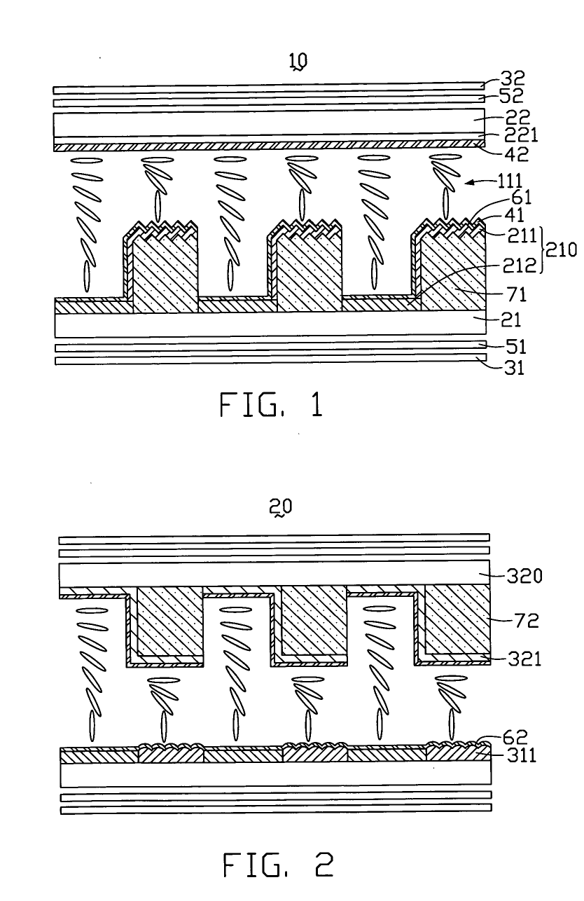

FIG. 1 is a schematic, exploded, side cross-sectional view of part of an LCD device according to a first embodiment of the present invention. The LCD device 10 includes a lower substrate 21, an upper substrate 22 disposed parallel to and spaced apart from the lower substrate 21, and a liquid crystal layer 111 having liquid crystal molecules (not labeled) sandwiched between the substrates 21 and 22. A plurality of chiral dopant molecules (not shown) are mixed in the liquid crystal layer 111.

A lower retardation film 51 and a lower polarizer 31 are orderly disposed on an outer surface of the lower substrate 21. A pixel electrode 210 and a lower alignment film 41 are orderly disposed on an inner surface of the lower substrate 21.

An upper retardation film 52 and an upper polarizer 32 are orderly disposed on an outer surface of the upper substrate 22. A transparent common electrode 221 and an upper alignment film 42 are orderly disposed on an inner surface of the upper substrate 22.

The LCD device 10 includes a plurality of pixel regions that span through the common electrode 221, the pixel electrode 210, and the liquid crystal layer 111 contained between the common and pixel electrodes 221, 210. Each of the pixel regions includes a reflection region (not labeled) and a transmission region (not labeled). Portions of the pixel electrode 210 in the reflection regions cooperate with and/or are configured as reflection electrodes 211, and portions of the pixel electrode 210 in the transmission regions are configured as transmission electrodes 212.

The transmission electrodes 212 are made of a transparent conductive material, such as indium-tin-oxide (ITO) or indium-zinc-oxide (IZO). The reflection electrodes 211 are made of metal with a high reflective ratio, such as Al or an Al—Nd alloy. The reflection electrodes 211 each have an uneven surface, thereby defining a plurality of bumps 61. The bumps 61 can scatter light beams in order to avoid the so-called mirror reflection effect. The reflection electrodes 211 are used for reflecting ambient light when the LCD device 10 operates in a reflection mode.

A passivation layer 71 is disposed between the reflection electrodes 211 and the lower substrate 21. Therefore, a thickness of the liquid crystal layer 111 in the reflection regions is less than a thickness of the liquid crystal layer 111 in the transmission regions. In this embodiment, the thickness of the liquid crystal layer 111 in the reflection regions is substantially half of that in the transmission regions. The passivation layer 71 has an uneven surface, thereby defining a plurality of bumps (not labeled). This configuration enables the reflection electrodes 211 to have the plurality of bumps 61.

The alignment films 41 and 42 are used to ensure that the liquid crystal molecules maintain a pre-tilt angle. The pre-tilt angle of the liquid crystal molecules adjacent to the upper alignment film 42 is in the range from 0° to 15°, and the pre-tilt angle of the liquid crystal molecules adjacent to the lower alignment film 41 is in the range from 75° to 90°.

In summary, in each pixel region of the LCD device 10, the liquid crystal molecules have a pre-tilt angle, which ensures that the liquid crystal molecules can more easily twist when a voltage is applied thereto. Thereby, the LCD device 10 has a fast response time. Moreover, the bumps 61 scatter light beams in order to avoid the so-called mirror reflection effect, so as to ensure that the LCD device 10 has a good quality display.

FIG. 2 is a schematic, exploded, side cross-sectional view of part of an LCD device according to a second embodiment of the present invention. The LCD device 20 has a structure similar to that of the LCD device 10. However, in the LCD device 20, a passivation layer 72 is disposed between a common electrode 321 and an upper substrate 320, the passivation layer 72 being located corresponding to reflection regions. Therefore, a thickness of the liquid crystal layer 111 in the reflection regions is less than a thickness of the liquid crystal layer 111 in transmission regions. Each of reflection electrodes 311 has an uneven surface, thereby defining a plurality of bumps 62. The bumps 62 can scatter light beams in order to avoid the so-called mirror reflection effect.

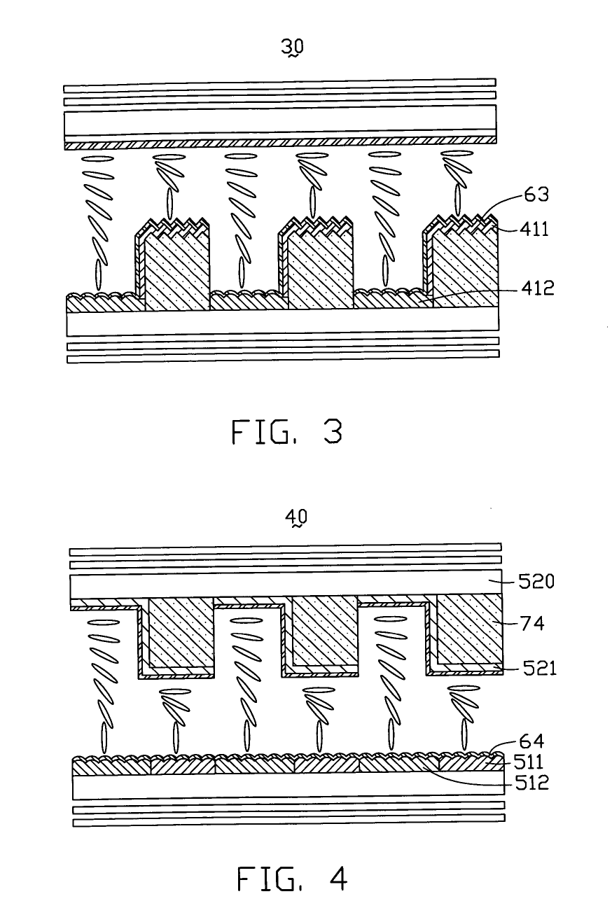

FIG. 3 is a schematic, exploded, side cross-sectional view of part of an LCD device according to a third embodiment of the present invention. The LCD device 30 has a structure similar to that of the LCD device 10. However, in the LCD device 30, reflection electrodes 411 and transmission electrodes 412 each have an uneven surface, thereby defining a plurality of bumps 63. The bumps 63 of the reflection electrodes 411 can scatter light beams in order to avoid the so-called mirror reflection effect. The bumps 63 of the transmission electrodes 412 can scatter light beams.

FIG. 4 is a schematic, exploded, side cross-sectional view of part of an LCD device according to a fourth embodiment of the present invention. The LCD device 40 has a structure similar to that of the LCD device 10. However, in the LCD device 40, a passivation layer 74 is disposed between a common electrode 521 and an upper substrate 520, the passivation layer 74 being located corresponding to reflection regions. Reflection electrodes 511 and transmission electrodes 512 each have an uneven surface, thereby defining a plurality of bumps 64. The bumps 64 of the reflection electrodes 511 can scatter light beams in order to avoid the so-called mirror reflection effect. The bumps 64 of the transmission electrodes 512 can scatter light beams.

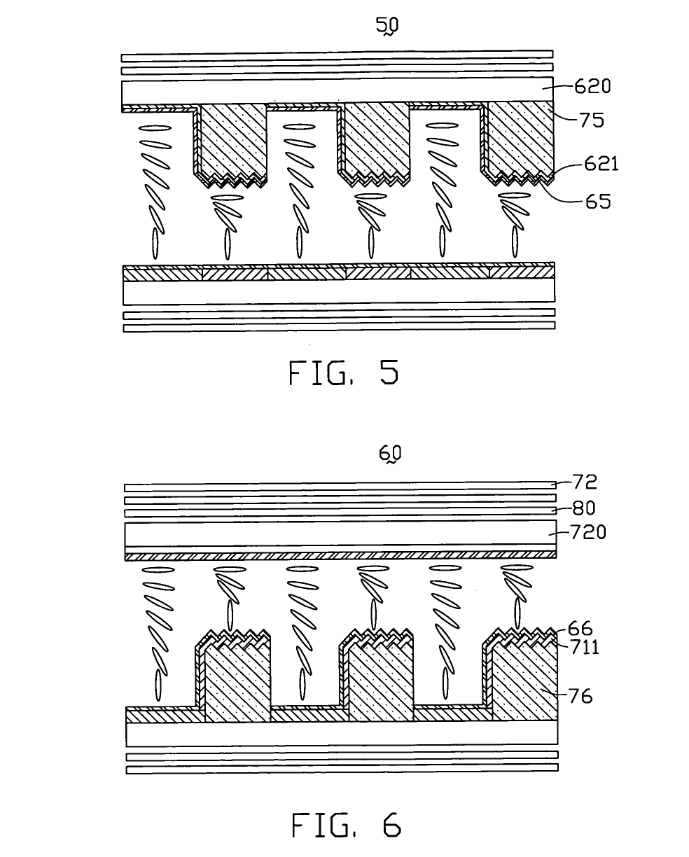

FIG. 5 is a schematic, exploded, side cross-sectional view of part of an LCD device according to a fifth embodiment of the present invention. The LCD device 50 has a structure similar to that of the LCD device 10. However, in the LCD device 50, a passivation layer 75 is disposed between a common electrode 621 and an upper substrate 620, the passivation layer 75 being located corresponding to reflection regions. The passivation layer 75 has an uneven surface, thereby defining a plurality of bumps 65. The bumps 65 can scatter light beams in order to avoid the so-called mirror reflection effect.

FIG. 6 is a schematic, exploded, side cross-sectional view of part of an LCD device according to a sixth embodiment of the present invention. The LCD device 60 has a structure similar to that of the LCD device 10. However, the LCD device 60 further includes a color filter 80 disposed between an upper substrate 720 and an upper polarizer 72. The color filter 80 includes a plurality of holes (not shown) corresponding to reflection regions. Reflection electrodes 711 each have an uneven surface, thereby defining a plurality of bumps 66. The bumps 66 can scatter light beams in order to avoid the so-called mirror reflection effect.

Various modifications and alterations are possible within the ambit of the invention herein. For example, the upper and lower retardation films may be quarter-wave plates. Furthermore, a thickness of the color filter corresponding to the reflection regions may be less than a thickness of the color filter corresponding to the transmission regions. Moreover, a pigment density of the color filter corresponding to the reflection regions may be lower than a pigment density of the color filter corresponding to the transmission regions.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal display device, comprising:
a first substrate and a second substrate;
a liquid crystal layer having liquid crystal molecules interposed between the first and second substrates;
a common electrode disposed at an inner surface of the first substrate;
a pixel electrode disposed at an inner surface of the second substrate; and
a plurality of pixel regions, each of the pixel regions defining a reflection region and a transmission region, the pixel electrode in the reflection regions being configured as reflection electrodes, and the pixel electrode in the transmission regions being configured as transmission electrodes;
wherein a thickness of the liquid crystal layer in the reflection regions is less than a thickness of the liquid crystal layer in the transmission regions;
a pre-tilt angle of liquid crystal molecules adjacent to one of the substrates is in the range from 0° to 15°, and a pre-tilt angle of liquid crystal molecules adjacent to the other substrate is in the range from 75° to 90°; and
each of the reflection electrodes has an uneven surface, thereby defining one or more bumps.

2. The liquid crystal display device as claimed in claim 1, wherein a plurality of chiral dopant molecules are mixed in the liquid crystal layer.

3. The liquid crystal display device as claimed in claim 1, wherein a passivation layer is provided between the reflection electrodes and the second substrate.

4. The liquid crystal display device as claimed in claim 1, wherein a passivation layer is provided between the common electrode and the first substrate, in areas corresponding to the reflection regions.

5. The liquid crystal display device as claimed in claim 1, further comprising an upper retardation film and an upper polarizer orderly disposed at an outer surface of the first substrate, and a lower retardation film and a lower polarizer orderly disposed at an outer surface of the second substrate, wherein the upper and lower retardation films are quarter-wave plates.

6. The liquid crystal display device as claimed in claim 5, further comprising a color filter between the upper polarizer and the first substrate.

7. The liquid crystal display device as claimed in claim 6, wherein the color filter includes a plurality of holes corresponding to the reflection regions.

8. The liquid crystal display device as claimed in claim 6, wherein a thickness of the color filter corresponding to the reflection regions is less than a thickness of the color filter corresponding to the transmission regions.

9. The liquid crystal display device as claimed in claim 6, wherein a pigment density of the color filter corresponding to the reflection regions is lower than a pigment density of the color filter corresponding to the transmission regions.

10. A liquid crystal display device, comprising:
a first substrate and a second substrate;
a liquid crystal layer having liquid crystal molecules interposed between the first and second substrates;
a common electrode disposed at an inner surface of the first substrate;
a pixel electrode disposed at an inner surface of the second substrate; and
a plurality of pixel regions, each of the pixel regions defining a reflection region and a transmission region, the pixel electrode in the reflection regions being configured as reflection electrodes, and the pixel electrode in the transmission regions being configured as transmission electrodes;
wherein a thickness of the liquid crystal layer in the reflection regions is less than a thickness of the liquid crystal layer in the transmission regions;
a pre-tilt angle of liquid crystal molecules adjacent to one of the substrates is in the range from 0° to 15°, and a pre-tilt angle of liquid crystal molecules adjacent to the other substrate is in the range from 75° to 90°; and
the reflection electrodes and the transmission electrodes each have an uneven surface, thereby defining a plurality of bumps.

11. The liquid crystal display device as claimed in claim 10, wherein a passivation layer is provided between the reflection electrodes and the second substrate.

12. The liquid crystal display device as claimed in claim 10, wherein a passivation layer is provided between the common electrode and the first substrate, in areas corresponding to the reflection regions.

13. The liquid crystal display device as claimed in claim 10, further comprising an upper polarizer and a color filter, the color filter being between the upper polarizer and the first substrate, the color filter including a plurality of holes corresponding to the reflection regions.

14. A liquid crystal display device, comprising:
a first substrate and a second substrate;
a liquid crystal layer having liquid crystal molecules interposed between the first and second substrates;
a common electrode disposed at an inner surface of the first substrate;
a pixel electrode disposed at an inner surface of the second substrate; and
a plurality of pixel regions, each of the pixel regions defining a reflection region and a transmission region, the pixel electrode in the reflection regions being configured as reflection electrodes, and the pixel electrode in the transmission regions being configured as transmission electrodes;
a pre-tilt angle of liquid crystal molecules adjacent to one of the substrates is in the range about 0° to 20°, and a pre-tilt angle of liquid crystal molecules adjacent to the other substrate is in the range about 70° to 90°; and
a passivation layer is disposed at one of the substrates, in areas corresponding to the reflection regions, and the passivation layer have an uneven surface thereby defining a plurality of bumps.

15. The liquid crystal display device as claimed in claim 14, wherein a thickness of the liquid crystal layer in the reflection regions is less than a thickness of the liquid crystal layer in the transmission regions;

16. The liquid crystal display device as claimed in claim 14, wherein the passivation layer is between the reflection electrodes and the second substrate.

17. The liquid crystal display device as claimed in claim 14, wherein the passivation layer is between the common electrode and the first substrate.
